(19) United States
(12) Patent Application Publication
(10) Pub. No.: US 2012/0261281 A1
(43) Pub. Date: Oct. 18, 2012

(54) Inherently Unstable Vase Container with Attached Magnet

(76) Inventor: Jonathan Mark Morgan, Columbus, OH (US)

(21) Appl. No.: 13/175,851

(22) Filed: Jul. 2, 2011

Related U.S. Application Data
(60) Provisional application No. 61/361,193, filed on Jul. 2, 2010.

(51) Int. Cl. B65D 79/00; B23P 17/04; A47G 7/06

(52) U.S. Cl. 206/216; 29/428

(57) ABSTRACT

One embodiment of an inherently unstable vase with a magnet (3) attached to the base of the vase container (1). One pole of the magnet (3) allows the vase to be magnetically attracted to any metal object, including a ferrous metal base (4) plate. A ferrous block (2) near the opposite magnet pole augments the force provided by the magnet. The center of gravity of the vase would not allow the vase to remain upright without the use of the magnetic forces. A non-ferrous material can be placed between the vase magnet (3) and base (4), hiding the method by which the inherently unstable vase remains upright. Vases can be magnetically attached to one another, creating multi-tier vase arrangements. Magnetic forces allow the vases to be easily arranged and reconfigured to the desired angle, height, and shape. Also, the magnetic forces inhibit the vase from toppling due to perturbations.

### CROSS-REFERENCE TO RELATED APPLICATIONS

This application claims the benefit of PPA Ser. No. 61/361,193, filed Jul. 2, 2010 by the present inventor, which is incorporated by reference.

### FEDERALLY SPONSORED RESEARCH

None.

### SEQUENCE LISTING

None.

### BACKGROUND

1. Field

This application relates to a novel container with an attached magnet. The center of gravity of the inherently unstable container would not allow the container to upright on a horizontal surface without the aid of the magnetic force between the base of the container and a magnetically attractive base. The invention makes use of a non-obvious arrangement of a magnet and magnetically attractive materials to provide a relatively great force to keep the vase from toppling. Vases are easily reconfigurable and can be magnetically attached to one another to produce innumerable intriguing and useful arrangements. The container can be used to hold a number of decorative or functional objects, including, but not limited to, flowers and water, pencils, candles, or paperclips.

2. Prior Art

Current containers meant to hold similar objects are generally free-standing, supported only by their flat base. Some currently existing non-patented containers may have a relatively high center of gravity, making them susceptible to being easily knocked over, but they are still designed to remain upright when placed on a flat horizontal surface, as long as the container does not experience too much perturbation. Similar vases, such as the Magnetic Vase made by Peleg Designs in Israel, are easily prone to being toppled because of their high center of gravity, and thus magnets are attached to the base of the vases to aid in keeping the vases upright when placed on a horizontal surface. Another example is the U.S. Pat. No. 5,816,548 granted to Blossom III, which depicts a vase that has an attached magnet. The magnet is meant to stabilize the vase in situations in which there is a great amount of activity (e.g., on a desk of a busy individual), but the center of gravity of the vase allows the vase to remain upright on a horizontal surface without the use of the magnet. Unlike the present invention, prior vases meant for use on horizontal surfaces are not inherently unstable without the use of magnetic forces.

In addition, the patent granted to Blossom III nor the Magnetic Vase created by Peleg Design does not use nor appreciate intriguing magnetic vase arrangements that can be achieved by magnetically attaching one vase to another. Unlike the present invention, prior magnetic vases were not designed to be non-permanently magnetically attached to one another, producing useful and aesthetically pleasing arrangement of containers.

Prior inventions relating to vases and floral displays disclose methods for mechanically mounting a vase or flower pot against a vertical surface. For example, U.S. Pat. No. 1,074,239 granted to Braun, U.S. Pat. No. 1,226,101 granted to Marsden, U.S. Pat. No. No. 1,758,130 granted to Shoemaker, and U.S. Pat. No. 4,137,668 granted to Kojo all depict variations of floral containers that are designed to be mounted permanently or semi-permanently to vertical surfaces. These prior inventions do not have the advantage of the present invention of allowing the vase to be relocatable on a magnetically-attractive vertical surface or, alternatively, allowing the vase to rest on a non vertical surface.

U.S. Pat. No. 1,868,023 granted to North, U.S. Pat. No. 5,195,270 granted to Domurat, U.S. Pat. No. 5,409,190 granted to Mattox, U.S. Pat. No. Des. 114,349 granted to Sparrow, U.S. Pat. No. Des. 247,941 granted to Gregorius, and U.S. Pat. No. Des. 365,041 granted to Dollinger also depict holders or receptacles that are designed for use only on vertical surfaces, unlike the present invention which allows for usage on vertical or non-vertical surfaces. Further, while these other patents propose inventions using suction cups or mechanical designs that permit the containers to be somewhat moveable, these inventions lack the ease of use that the present invention has by incorporation of the magnet.

U.S. Pat. No. 2,964,812 granted to Cook, U.S. Pat. No. 3,109,619 granted to Krug et al., U.S. Pat. No. 3,159,372 granted to Mclntosh, and U.S. Pat. No. 3,713,614 granted to Taylor disclose examples of magnets used to hold objects in place on a magnetically-attractive surface. However, in these examples, the holders are meant to support specific devices. The magnetic holders are not capable of containing an array of different objects, as is possible with the present invention. Further, prior art does not use nor appreciate the additional magnetic holding force achieved when a magnet is placed between two ferrous metals. The holding force achieved between a magnet and a plate of ferrous material is greatly augmented when both north and south faces of the magnet are in direct contact or near contact to ferrous material. None of the prior inventions have the advantage of the present invention that provides a relatively much greater magnetic holding force with a non-obvious arrangement of one magnet and two magnetically attractive materials, one placed near each pole of the magnet. A much greater magnetic holding force is obtained when a magnetically attractive material is placed in contact or close proximity to both north pole and south pole surfaces of a single magnet. As a result, the containers of the present invention have a greater maximum holding weight capacity than the prior art that requires only one plot of a magnet to be near a ferrous object.

Thus, several advantages of one or more aspects are to provide a magnetic container with greater holding capacity than previously realized for a given magnet type, size, and shape. Other advantages of one or more aspects are to provide a container that is inherently unstable, that would topple if set on a horizontal surface, without the use of a magnet. These and other advantages of one or more aspects will become apparent from a consideration of the ensuing description and accompanying drawings.

### SUMMARY

This present invention is comprised of an inherently unstable container to hold any number of objects, an attached magnet, a ferrous block attached near one pole of the magnet, and a magnetically-attractive base placed near the opposite pole of the magnet. The attached magnet may vary in composition, dimension, and shape. The magnet supports the weight of the container and the objects within the container, even if a small gap exists between the base of the container and the magnetically-attractive base. The gap can be maintained with a tablecloth, for example, between the base of the container and the magnetically-attractive base. The tablecloth can hide the mechanism, magnetic forces, by which the vase remains upright. The result is an intriguing and aesthetically pleasing vase.

The invention is unique, as the inherently unstable vase will not otherwise remain upright without the magnetic attraction between the magnet attached to the base of the container and the magnetically-attractive base. Further, unlike prior art, the magnet attached to the base of the vase is placed between two magnetically attractive materials, with both the north and south magnet faces near a ferrous metal. Such an arrangement can support up to 2 times the weight within the vase, compared to the vase design with only one face of the magnet near a ferrous metal. In addition, vases can be non-permanently magnetically attached to one another, producing an attractive and useful vase display. Vases can be magnetically stacked on top of one another to achieve innumerable vase arrangement shapes and heights.

### DRAWINGS

### Figures

FIG. 1 shows a flower inside a cylindrical vase.

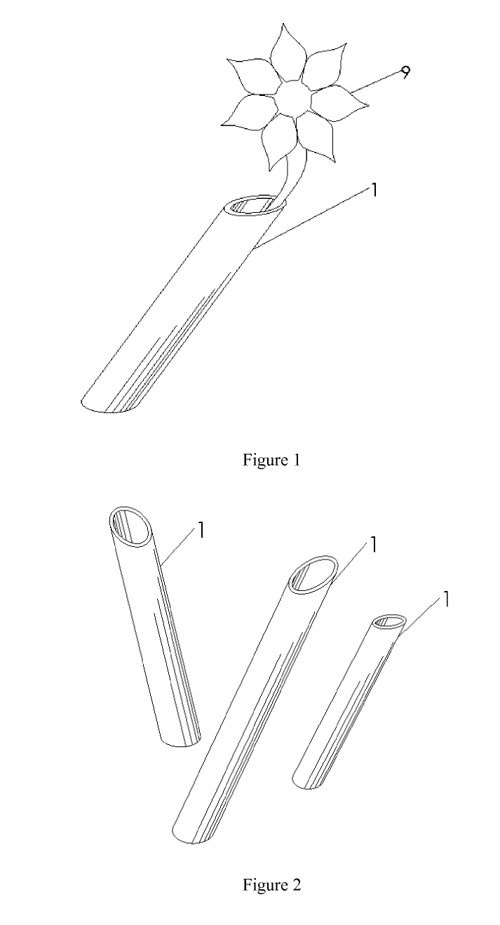

FIG. 2 shows an arrangement of multiple empty cylindrical vases.

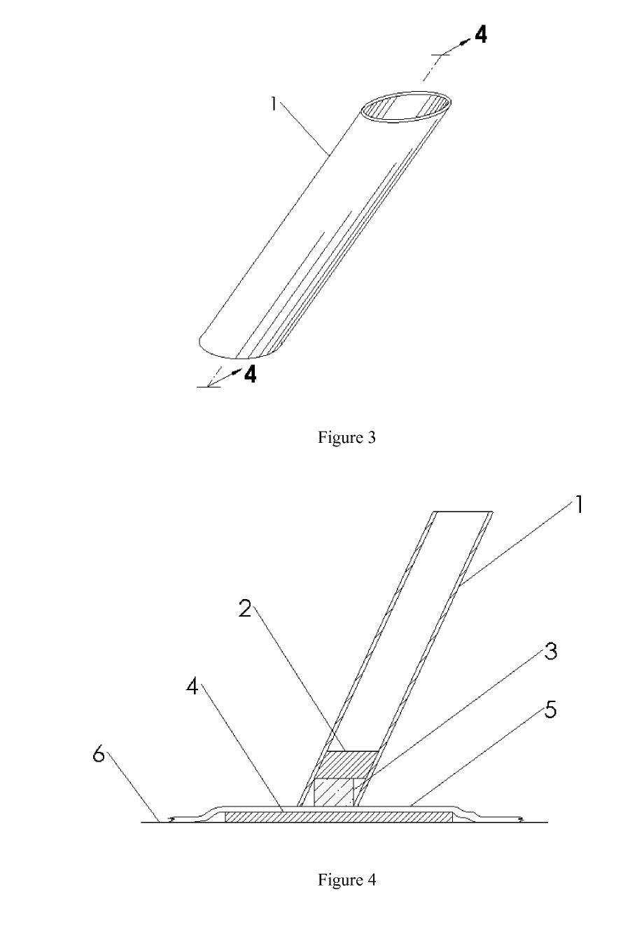

FIG. 3 shows a single vase.

FIG. 4 shows a cross sectional view of a vase, taken along lines 4-4 of FIG. 2. A tablecloth hides the mechanism, magnetic forces, by which the vase remains upright.

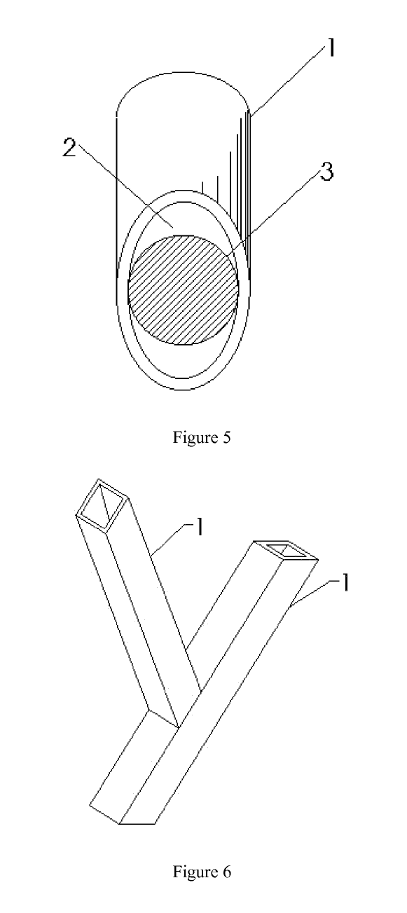

FIG. 5 shows the bottom view of a vase.

FIG. 6 shows two prismatic vases. One vase is magnetically attached to the second vase composed of a magnetically attractive material.

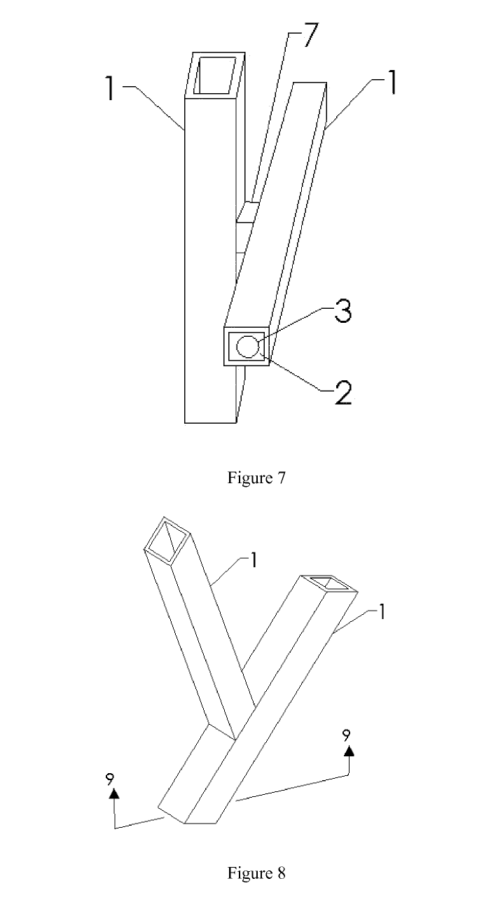

FIG. 7 shows two prismatic vases magnetically attached to one another. Both vase containers are composed of a magnetically attractive material. A magnet is placed between the two vase surfaces to suspend one of the vases, with the magnet as the hinge point.

FIG. 8 shows two vases magnetically attached to one another. The vase containers are not composed of a magnetically attractive material. A magnet is placed inside one vase container in order to magnetically attach the other vase.

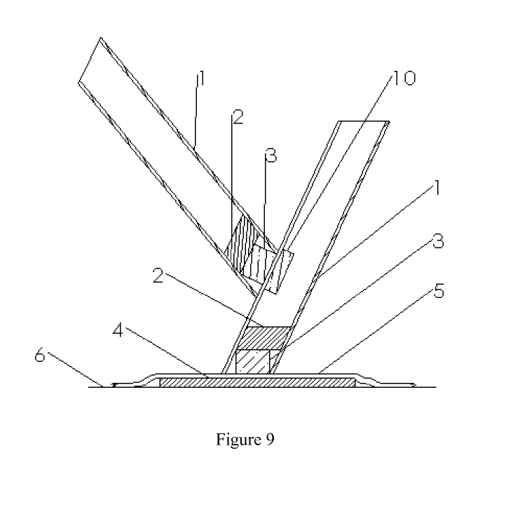

FIG. 9 shows a cross sectional view of two vases magnetically attached to one another, taken along lines 9-9 of FIG. 8.

### REFERENCE NUMERALS

1 Vase container
2 Block composed of ferrous metal
3 Container magnet
4 Base composed of ferrous metal
5 Tablecloth
6 Table surface
7 Hinging magnet
8 Flower
9 Side magnet

### DETAILED DESCRIPTION

### FIGS. 1, 2, 3, 4, and 5

### First Embodiment

A typical embodiment of the vase is shown in FIGS. 1, 2, 3, 4, and 5. As shown in the drawings, the vase invention primarily consists of four parts: a container (1), a magnetically attractive block (2), an attached container magnet (3), and a magnetically attractive base (4). The container (1) may be composed of ceramic, glass, plastic, or other materials suitable for holding use. Further, the container's (1) cross section may be of any shape, such as a circle or rectangle, and the cross section shape and dimensions may vary along the container's (1) length. The container magnets (3) depicted are prismatic and cylindrical but may be of different shapes to suit the size and weight of the vase and anything within the vase, such as a flower (9). N52 grade neodymium magnets, or any other type or grade of magnet, may be used for the container magnet (3). The magnetically attractive block (2) and base (4) may be of different shapes as well. The magnetically attractive block (2) and base (4) must be composed of materials that are attracted to a magnet, such as a ferrous metal or another magnet. Further, the block (2) and the base (4) may be less than ⅛th inch thick. Such a thin base (4) easily allows the base (4) to be hidden under the tablecloth (5), disguising the method by which the unstable container (1) remains upright. The magnetically attractive base (4) can be placed on an inclined or horizontal surface, such as a table (6).

The container magnet (3) is secured to the container (1) and/or the magnetically attractive block (2) by any suitable adhesive applied to the surface areas at which the magnet (3) is attached to the magnetically attractive block (2) and/or the container (1). An epoxy adhesive can be used to assemble the container (1), block (2), and container magnet (3), as well as provide a waterproof seal at the base of the container (1). The container (1) and the block (2) can also be non-permanently attached to one another or permanently attached to one another by any suitable means, including welding. In the embodiments shown, the container magnet (3) is secured such that the lower base of the container magnet (3) is aligned along, or close to, the same plane as the bottom of the container. Further, in the embodiments shown, the inherently unstable container (1) is shaped such that its center of gravity would not allow the container to remain upright without the use of magnetic forces.

### Operation—FIG. 4—First Embodiment

A preferred embodiment is shown in FIG. 4. The magnetically attractive base (4) is covered with material, such as a tablecloth (5), and the container (1) is placed on top of the tablecloth (5) over top of the magnetically attractive base (4). The container magnet (3) is magnetically attracted to the nearby magnetically attractive base (4). The magnetically attractive base (4) can be omitted if the table (6) on which the vase sets is composed of a ferrous material. Without the aid of magnetic forces, the otherwise inherently unstable vase would fall. The tablecloth (5) hides the method, magnetic forces, by which the vase remains upright. The result is an intriguing and useful vase.

Further, placing the magnet between two magnetically attractive materials, the magnetically attractive block (2) and base (4), can augment the maximum weight capacity allowed within the vase beyond twice the capacity achieved when not utilizing the block (2). Although, the block (2) composed of a ferrous metal can be omitted. The container magnet (3) can be adhered to the container (1) without use of the block (2). An epoxy adhesive can both adhere the magnet (3) to the container (1) and provide a waterproof seal inside the container. Multiple vases, as shown in FIG. 2, can be arranged on one or more magnetically attractive bases (4). The tablecloth (5) can be omitted if it is not desired that the method by which the vase remains upright, magnetic forces, is hidden. The magnetic forces allow the vases to be easily relocated and rearranged.

### Operation—FIG. 6—Second Embodiment

FIG. 6 shows a vase embodiment in which the vases are magnetically attached to one another. One vase is magnetically attracted to the magnetically attractive ferrous container (1) of the other vase. Vases with ferrous containers (1) can continue to be magnetically attached to one another, constructing multi-tier vase arrangements. The ability of vases to be magnetically stacked on top of one another allows vase arrangements to be easily customized for practical and aesthetic purposes. Magnetic vase stacking allows vase arrangements to be easily varied in height and shape, unlike any prior art.

### Operation—FIG. 7—Third Embodiment

Two vases can also be attached to one another by the method shown in FIG. 7 if both vase containers (1) are composed of ferrous material. A hinging magnet (7) is placed between the two vases. The hinging magnet suspends one of the vases, with the hinging magnet (7) acting as the pivot point between the vases. The hinging magnet (7) is magnetically attracted to the two ferrous vase containers (1).

### Operation—FIGS. 8 and 9—Fourth Embodiment

Vases can be also magnetically attached to one another, regardless of the composition of their containers (1), as seen in FIGS. 8 and 9. A side magnet (10) is placed on the interior of one vase. The side magnet (10) is magnetically attracted to the container magnet (3) of a second vase, keeping the second vase upright. The side magnet (10) can also be replaced by a ferrous metal. Magnetic attachment of one vase to another allows for an unlimited number of intriguing, reconfigurable, and useful vase configurations.

Accordingly, it is to be understood that the embodiments of the invention herein described are merely illustrative of the application of the principles of the invention. Many other variations are possible. Reference herein to details of the illustrated embodiments is not intended to limit the scope of the claims, which themselves recite those features regarded as essential to the invention.

I claim:

1. A vase comprising:
a. a container with a center of gravity that would cause said container to topple from an upright position if set on a horizontal surface,
b. a magnet attached to the bottom of said container, wherein a magnetic pole of said magnet can engage a ferrous object,
whereby magnetic forces from said magnet will prevent said container from toppling due to its own center of gravity, due to the center of gravity of any objects inside said container, or due to perturbations.

2. The vase of claim 1 wherein said container is composed of a ferrous material,
whereby said container can be non-permanently magnetically attached to another said container.

3. The vase of claim 1, further including a ferrous block attached near opposite said magnetic pole of said magnet,
whereby the magnetic force provided by said magnet is augmented by said block favorably altering the magnetic field.

4. A method to disguise the means by which an inherently unstable vase with an attached magnet on its base remains upright, comprising the steps:
a. covering a ferrous object with a thin non-ferrous material;
b. placing said inherently unstable vase on top of said non-ferrous material and ferrous object;
whereby said magnet engages said ferrous material, preventing said inherently unstable vase from toppling due to its own center of gravity, due to the center of gravity of any objects inside said container, or due to perturbations.
